(19) United States
(12) Patent Application Publication
(10) Pub. No.: US 2024/0220738 A1
(43) Pub. Date: Jul. 4, 2024

(54) Increasing Comprehension Through Playback of Translated Speech

(71) Applicant: Meta Platforms Technologies, LLC, Menlo Park, CA (US)

(72) Inventor: Bhramara TIRUPATI, Redmond, WA (US)

(21) Appl. No.: 18/605,037

(22) Filed: Mar. 14, 2024

Related U.S. Application Data
(60) Provisional application No. 63/459,336, filed on Apr. 14, 2023.

(51) Int. Cl. G06F 40/47; G10L 15/00

(52) U.S. Cl. CPC G06F 40/47; G10L 15/005

(57) ABSTRACT

The disclosed technology includes capturing speech audio from a sound source, modifying the captured speech audio to have speech patterns that match that of the user, and playing back the modified speech audio content to the user to facilitate comprehension. Such a design once tested has applicability in social situations for international visitors as well as immigrant populations in a foreign country. Another use case for this technology would be improving reading and listening comprehension in children or assisting special needs children and adults with an assistive technology. In such cases, the playback audio could be the voice of a caretaker, parent or a medical professional as appropriate for the situation.

### CROSS REFERENCE TO RELATED APPLICATION(S)

This application claims priority to U.S. Provisional Application No. 63/459,336, filed on Apr. 14, 2023, titled “Increasing Comprehension Through Playback of Translated Speech,” which is incorporated herein by reference in its entirety.

### FIELD OF THE INVENTION

The present disclosure generally relates to speech translation, and specifically relates to increasing comprehension through playback of translated speech.

### BACKGROUND

Listening comprehension of a non-native language is a key challenge in several use cases that involve traveling for instance or day to day activities that require comprehension for non-native English speakers. Even when equipped with good reading comprehension, listening comprehension for non-native speakers remains a big challenge due to varying accents. A conventional solution to the problem involves mobile applications which can provide a speech to text type of translation, but often do not provide real time translation in day-to-day situations.

### BRIEF DESCRIPTION OF THE DRAWINGS

FIG. 1 is a block diagram illustrating an overview of devices on which some implementations of the present technology can operate.

FIG. 2 is a block diagram illustrating an overview of an environment in which some implementations of the present technology can operate.

### DETAILED DESCRIPTION

Users who are non-native speakers of a language may have trouble understanding the language when spoken with an accent. An accent refers to a way of pronouncing a language that is distinctive to a particular area or country, or background. For example, a native English speaker located in the United States may have acquired one of a variety of accents, such as a Boston accent, or a Southern accent. An accent may have features such as the stress, pitch, and intonation on consonants or vowels. To illustrate different vowel pronunciations, the word “lot” pronounced by a person with an American accent may sound like “laht” (e.g., lat), while the word “lot” pronounced with an English accent may sound like “lawt” (e.g., lat). A non-native English speaker may not be able to discern the content of the speech due to these differences, and the speed at which words are spoken. However, the non-native speaker is more likely able to discern the content of the speech once hearing the language spoken in a voice with similar speech patterns as themselves. Thus, an alternative solution includes capturing speech audio from a sound source, modifying the captured speech audio to have speech patterns that match that of the user, and playing back the modified speech audio content to the user to facilitate comprehension. Such a design once tested has applicability in social situations for international visitors as well as immigrant populations in a foreign country. Another use case for this technology would be improving reading and listening comprehension in children or assisting special needs children and adults with an assistive technology. In such cases, the playback audio could be the voice of a caretaker, parent or a medical professional as appropriate for the situation.

An audio system that is configured to translate captured speech audio signals and modify captured speech audio based on the characteristics of a user's voice, is disclosed herein. The audio system may be implemented in wearable devices which includes, and is not limited to, head-mounted devices such as artificial reality headsets. In some embodiments, the audio system can translate from one language to another.

The audio system may include a transducer array, a sensor array, and an audio controller. Some embodiments of the audio system may have more or fewer components than described here. The audio system captures speech audio from a sound source, modifies the captured speech audio to have speech patterns that match that of the user, and presents the audio content to the user using one or more transducers of the audio system. The audio system generates one or more acoustic transfer functions for a user and may use the one or more acoustic transfer functions to generate audio content for the user. The audio controller may include a speech translation module, and a data storage. Similarly, other embodiments of the audio controller may have more or fewer components than described. In some embodiments, the audio system may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multi-layer perceptrons, convolutional neural networks (CNNs), recurrent neural networks (RNNs), sequence-to-sequence models, generative adversarial networks, automatic speech recognition (ASR) models, or transformers.

The sensor array of the audio system detects sounds within the local area of the headset. The sensor array includes a plurality of acoustic sensors. An acoustic sensor captures sounds emitted from one or more sound sources in the local area (e.g., a room). Each acoustic sensor is configured to detect sound and convert the detected sound into an electronic format (analog or digital). The acoustic sensors may be acoustic wave sensors, microphones, sound transducers, or similar sensors that are suitable for detecting sounds. The data store stores data for use by the audio system. Data in the data store may include sounds recorded in the local area of the audio system (e.g., speech from a sound source), speech profiles associated with certain speech and/or audio characteristics, audio content, head-related transfer functions (HRTFs), transfer functions for one or more sensors, array transfer functions (ATFs) for one or more of the acoustic sensors, sound source locations, virtual model of local area, direction of arrival estimates, sound filters, and other data relevant for use by the audio system, or any combination thereof.

The audio controller of the audio system processes information from the sensor array that describes sounds detected by the sensor array. The audio controller may comprise a processor and a computer-readable storage medium. The audio controller may include a speech translation module. The speech translation module may be configured to translate the captured speech audio into a target language. In other embodiments, the speech translation module may modify the captured/translated speech audio based on the speech patterns of the user's voice. In some embodiments, the translation functionality of the audio system may be user activated (e.g., wake up word, depressing a button on the wearable device). In other embodiments, the audio system may automatically process detected speech audio above a threshold amplitude.

The audio system may capture and analyze recordings of the user's voice to create a speech profile for the user. A speech profile may be associated with one or more determined speech parameters, the speech parameters describing characteristics of a recording of speech audio, such as the spoken language or dialect, stress, pitch, and intonation on consonants or vowels. A speech profile can be associated with English spoken with a type of American accent, such as a Boston accent or a Southern accent. In some embodiments, the user may select, from a list of voices, their preferred playback voice, each associated with a corresponding speech profile. In some embodiments, the user's own voice may be selected as a playback voice.

The audio system may recognize the captured speech audio as the target language chosen by the user. The wearable device plays back the captured speech in the user's preferred playback voice. In other embodiments, the captured speech audio is translated into English and a corresponding text transcription may be displayed to the user on the display elements of the wearable device or on an application on the user's mobile device, in addition to being played back to the user in a voice with similar speech patterns of the user in real time.

The audio system may recognize the captured speech audio as a language different from the target language chosen by the user. The user may select, from a list of languages, a target language to translate recorded speech audio into. For example, if English is chosen as a target language, captured speech audio in a different language (e.g., Japanese) is translated into English and played back to the user in a voice with similar speech patterns as the user in real time. The audio controller may implement one or more machine-learned models (e.g., ASR models) to predict the speech profile of a captured speech audio by using extracted speech parameters of the captured speech audio recording and modify the predicted speech profile of the captured speech audio to the speech profile of the user. In some embodiments, the speech translation module is configured to convert the captured speech audio into one or more representations of the captured speech audio for input to one or more machine-learned models. The one or more machine-learned models may receive, as input, one or more representations of the captured speech audio, and outputs a speech profile associated with the determined characteristics of the one or more representations. An example representation of the captured speech audio includes a spectrogram, which is a visual representation of the amplitude and frequencies of the audio signal over time. In other embodiments, the speech translation module may be configured to convert captured speech audio into Mel-Frequency Cepstral Coefficients (MFCCs), a representation of short-term spectrum of sounds.

The one or more machine-learned models may be configured to learn a mapping between the predicted speech profile of the captured speech audio (e, g, the sound source) and the speech profile of the user. The machine-learned models may be configured to learn the conversion of words and phrases between speech profiles using determined speech parameters. The machine-learned models may also be configured to modify the speech pattern of the captured speech audio to resemble the speech pattern of the user's voice. For example, the machine-learned models may slow down the speed of the captured speech audio to match the speed at which the user speaks. The modified captured speech audio content is presented to the user through the one or more transducers of the audio system.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

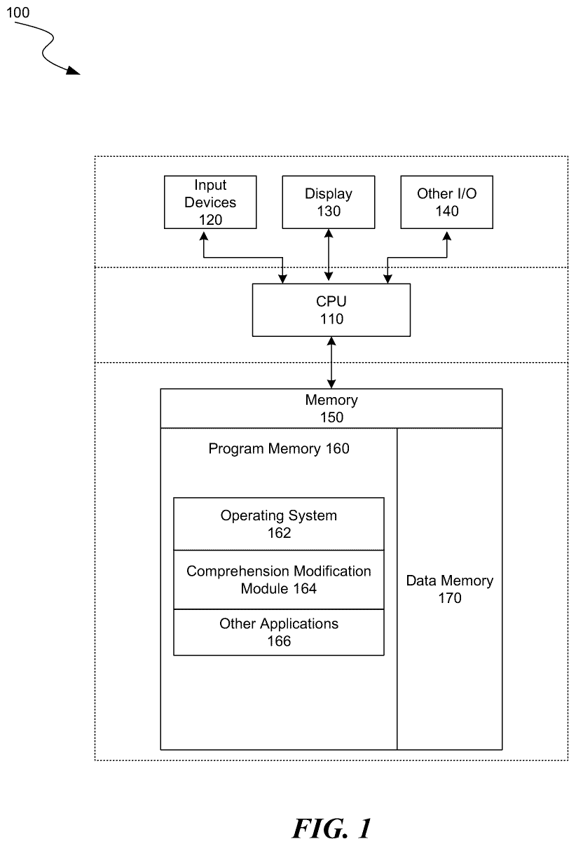

FIG. 1 is a block diagram illustrating an overview of devices on which some implementations of the disclosed technology can operate. The devices can comprise hardware components of a device 100 that can modify audio to increase comprehension. Device 100 can include one or more input devices 120 that provide input to the Processor(s) 110 (e.g., CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera- or image-based input device, a microphone, or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, comprehension modification module 164, and other application programs 166. Memory 150 can also include data memory 170, configuration data, settings, user options or preferences, etc., which can be provided to the program memory 160 or any element of the device 100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

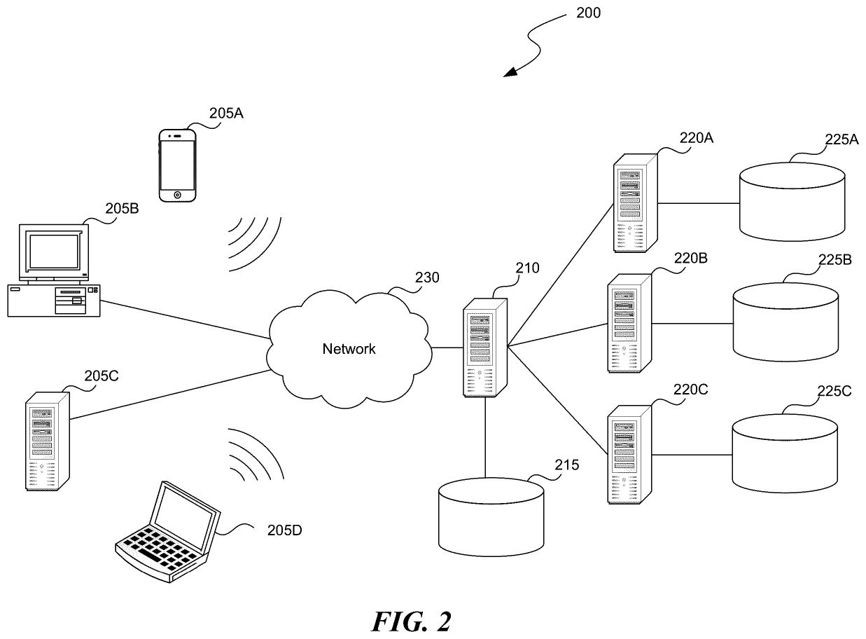

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g., store) information. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

### Additional Confiquration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
capturing speech audio signals from a sound source in a local area of an audio system;
determining a speech profile of the sound source using the speech audio signals;
generating translated audio signals using the captured speech, the speech profile of the sound source, and a speech profile of a user of the audio system, the translated audio signals having the speech profile of the user; and
presenting the translated speech signals as audio content to the user.

2. A computer-readable storage medium storing instructions that, when executed by a computing system, cause the computing system to perform a process as shown and described herein.

3. A computing system
one or more processors; and
one or more memories storing instructions that, when executed by the one or more processors, cause the computing system to perform a process as shown and described herein.
